(19) United States
(12) Patent Application Publication
(10) Pub. No.: US 2025/0018352 A1
(43) Pub. Date: Jan. 16, 2025

(54) MOLTEN METAL SUBMERGENCE IMPELLER

(71) Applicant: Oculatus LLC, Greenacres, WA (US)

(72) Inventors: Robert B. Wagstaff, Greenacres, WA (US); Brent M. Opdendries, Post Falls, ID (US); Samuel R. Wagstaff, Marietta, GA (US)

(73) Assignee: Oculatus LLC, Greenacres, WA (US)

(21) Appl. No.: 18/712,912

(22) PCT Filed: Nov. 22, 2022
(86) PCT No.: PCT/US2022/050771

§ 371 Date: May 23, 2024

Related U.S. Application Data
(60) Provisional application No. 63/282,618, filed on Nov. 23, 2021.

(51) Int. Cl. B01F 27/92; B01F 101/45; F04D 7/06; F04D 29/02; F04D 29/22

(52) U.S. Cl. CPC B01F 27/92; F04D 7/065; F04D 29/026; F04D 29/2216; B01F 2101/45

(57) ABSTRACT

A mixing impeller for submerging liquid material from a surface to a lower portion of the liquid material by rotating the impeller while the impeller is submerged within the liquid. The impeller includes a helical impeller having one or more surfaces at an angle with respect to the drive shaft of the impeller and a plate perpendicular to the drive shaft. The plate is coupled to the helical impeller at a distal end of the impeller.

### RELATED APPLICATIONS

This application claims priority to U.S. Provisional Application No. 63/282,618, filed on Nov. 23, 2021, the entire contents of which is incorporated herein by reference for all purposes.

### BACKGROUND

While processing molten materials and liquids such as molten metal it may be important to ensure even distribution of material within a furnace or container. In some examples, one type of pump for pumping molten metal rotates an impeller on the end of a shaft inside an impeller chamber of a furnace. The pump may be used to circulate molten metal or to transfer molten metal.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a top view of a furnace equipped with a side well chamber and submergence impeller, according to the instant disclosure.

FIG. 2 illustrates an example of a submergence impeller, according to the instant disclosure.

FIG. 3 illustrates an example of a submergence impeller, according to the instant disclosure.

FIG. 4 illustrates an example set a submergence impeller in a mixing chamber, according to the instant disclosure.

FIGS. 5-6 illustrate fluid dynamics models of the submergence impeller rotating at a first speed, according to the instant disclosure.

FIGS. 7-8 illustrate fluid dynamics models of the submergence impeller rotating at a second speed, according to the instant disclosure.

FIGS. 9-10 illustrate fluid dynamics models of the submergence impeller rotating at a third speed, according to the instant disclosure.

FIGS. 11-12 illustrate fluid dynamics models of the submergence impeller rotating at a fourth speed, according to the instant disclosure.

FIGS. 13-14 illustrate fluid dynamics models of the submergence impeller rotating at a fifth speed, according to the instant disclosure.

FIG. 15 illustrates submergence and surface subduction of a molten metal using a submergence impeller, according to the instant disclosure.

### DETAILED DESCRIPTION

Systems and devices described herein are related to submergence and mixing impellers for mixing molten metals during molten metal processing. Molten metals include metals such as aluminum, copper, steel, zinc, magnesium, and other metals raised to a temperature to cause them to reach a liquid state to prepare for further processing such as casting into various shapes. Submergence enables the impeller to cause a surface layer of the molten metal, which may include chips or other recently introduced material, to subduct below the surface and thereby increase the temperature of the surface layer and materials through increased surface area contact with the liquid bath of molten metal. By increasing submergence and mixing of material within a molten bath, a melt rate of the material may be increased. Increased temperature homogeneity as a result of the mixing may reduce hot spots and over-heating of portions of the molten bath. Additionally, in some examples, dross or waste may build up on a surface of the material as the molten metal oxidizes due to contact with the surrounding environment. Typical impeller designs may be configured to pump molten metal from one location to another but may not provide submergence and instead may provide surface turbulence that may increase a dross buildup and reduce molten metal yields. The impeller design described below may enable improved melt rates as described above as well as improved dross buildup (e.g., reduction in dross buildup) by submerging surface layers and increasing recovery of material that may otherwise be lost to dross by re-submerging within the molten bath to re-melt and recover the metal.

As chips or other material is added to a molten bath the chips or material may remain on the surface of the molten bath due to surface tension and oxide presence at the surface. Without submergence, the added material may have a tendency to remain at the surface and oxidize, reducing recovery and yield of added material. The impeller described herein provides for submergence of surface material as well as overall mixing of a molten bath ensuring melting of added material such as chips or recycled material. In some examples, the added material may include fluxes or salts used in scrubbing oxides from metals to recover unoxidized material while separating oxides for removal.

The impeller described herein may be used in a side well or pumping location to move molten metal from a first location to a second location using the pumping action of the impeller. For example, a side well may be configured to pump material from a main furnace bath region and while pumping, may provide an opportunity for introducing material such as metal chips, alloying elements, fluxes, or other elements for treatment and processing. As the material is pumped and mixed, the melt rate of the bath is increased, and the homogeneity of the molten metal is increased as well. The impeller described herein generates a submergence vortex that circulates material from an upper region of the molten metal bath to a lower region of the molten metal bath. The impeller enables such vortex generation at relatively low rotational speeds (e.g., ten to sixty rpm). The impeller may be driven by a motor such as an electric motor and may be driven through a gearbox to control speed, torque, or other rotational parameters of the impeller.

The impeller includes a drive shaft that may be driven by the motor system at a desired speed. The drive shaft may have varying lengths based on the depth of the molten bath, but may be from twenty to one hundred and twenty centimeters in length. The drive shaft enables the impeller to reach at or near a bottom of the molten bath. The drive shaft may be coupled to a gearbox or motor at or near a proximal end of the drive shaft and may include a helical impeller and plate at a distal end of the drive shaft. The impeller is positioned at or near the distal end of the drive shaft. The helical impeller includes one or more fins that extend perpendicularly or near perpendicular with the drive shaft and include a surface that wraps around, at least part of, the drive shaft and forms a helical surface. The helical impeller may include one, two, three, four, or more helical shaped surfaces that form the helical impeller. The plate may be positioned at the distal end of the drive shaft and may be coupled with the helical impeller such that the surfaces that form the helical impeller intersect and couple with the plate.

In an embodiment, the impeller includes a flared portion coupled to the drive shaft around which the helical impeller is formed. The flared portion may be a portion of the drive shaft that increases in diameter from a first diameter to a second diameter. The flared portion may increase linearly, exponentially, parabolically, hyperbolically, irregularly, or otherwise from the first diameter to the second diameter. The flared portion may serve to force material such as molten metal away from the drive shaft after submerging towards the plate. The flared portion may terminate at the plate.

In some examples the helical impeller may couple to the plate through a vertical surface. In such examples, the helical impeller with surfaces positioned at an incline with respect to the drive shaft may couple with one or more vertical surfaces adjacent the plate. The vertical surfaces may, in some examples, increase radial movement away from the drive shaft at or near the plate.

In some examples, the impeller may be formed of a uniform material such as a metal (e.g., stainless steel, steel, cast iron, etc.), a graphite, silicon carbide, a refractory material, or other suitable material that may maintain rigidity and strength within a molten metal bath. In some examples the impeller may be formed of a composite, with a drive shaft formed of a first material or including a first material with the plate and impeller formed of a second material. In some examples the drive shaft may include a metal while the impeller and plate include a graphite or refractory. In some examples the impeller may be formed of a material such as a metal and coated with a temperature resistant material such as a refractory material. In some examples, the impeller may be formed of SIFCA® refractory slurry with stainless steel fiber offered by Wahl Refractory Solutions of Fremont, OH.

The present description provides an overall understanding of the principles of the structure, function, manufacture, and use of the systems and methods disclosed herein. One or more examples are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

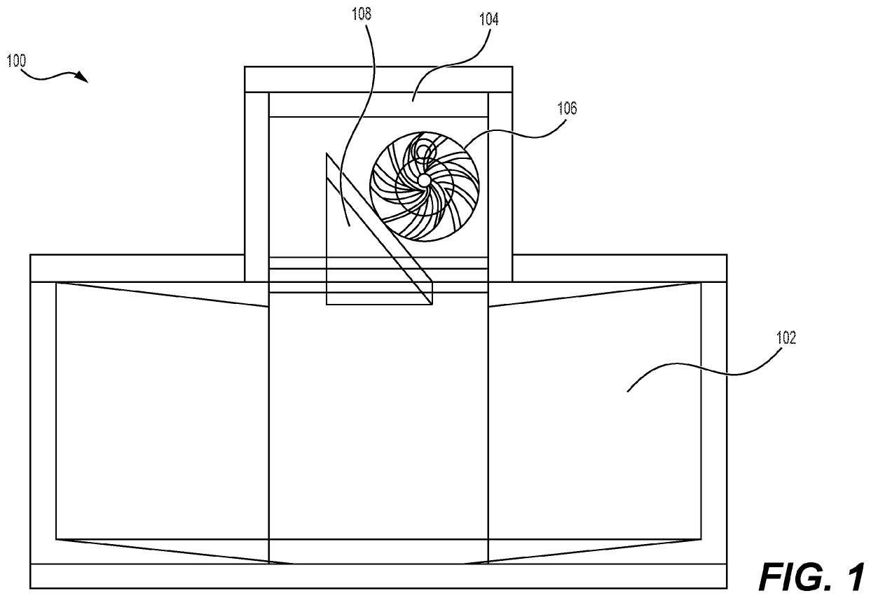

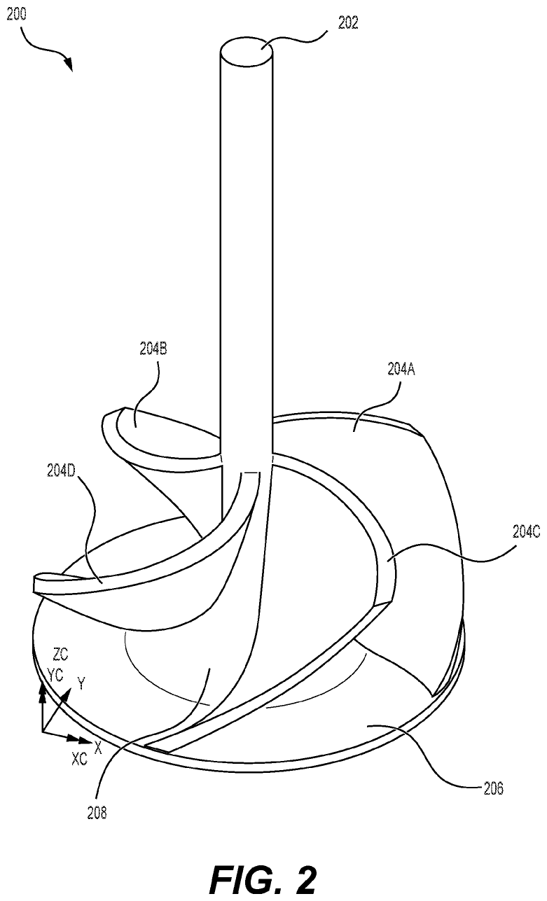

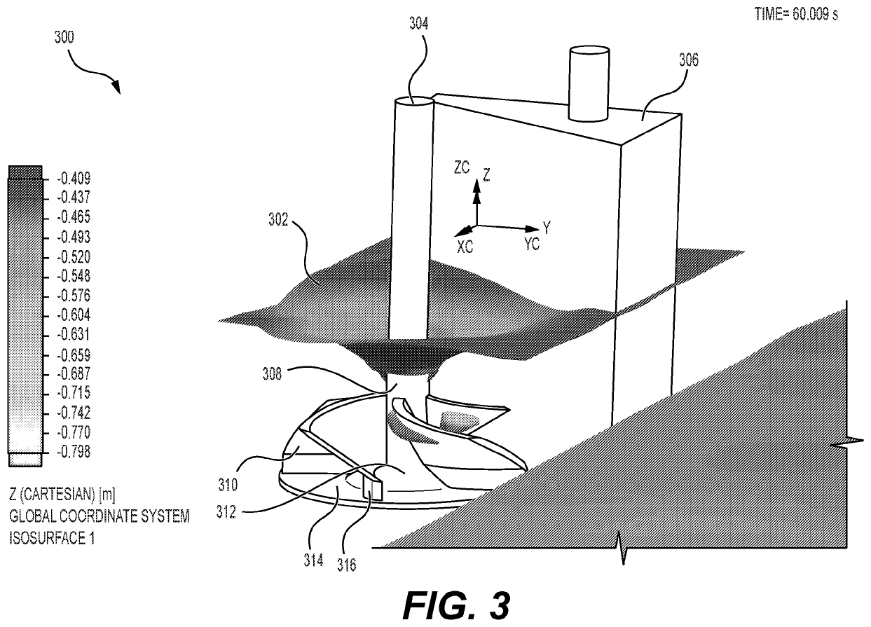

FIG. 1 illustrates a top view of a furnace 100 equipped with a side well chamber 104 and submergence impeller 106, according to the instant disclosure. The submergence impeller 106 may be an example of the submergence impellers shown and described in further detail with respect to FIGS. 2-3 below. The furnace 100 may be equipped with heating elements such as burners configured to raise the temperature to a melting temperature of a particular metal. The furnace 100 is shown in a top view and is shown having a main bath 102 where the majority of the molten metal is held within the furnace as well as a side well chamber where material may be pumped by the submergence impeller to circulate molten metal within the main bath 102. The side well chamber 104 may also be a chamber where chips, recycled material, and additional metal, flux, or material may be added for melting or treatment of the molten bath within the main bath 102. A shaped block 108 may be included within the side well chamber 108 that may increase a directionality of molten metal pumped through the side well chamber 104. The shaped block may be formed of the same material as the lining of the furnace and defines a conduit through the side well chamber 104 where metal may enter at a first position and pass the submergence impeller 106 before exiting the side well chamber at a second position. The furnace 100 may be a recycle furnace configured to recover metal from recycled materials added to the side well chamber such as chips, shreds, or other recycle material. In some examples, the furnace 100 may be a processing furnace such as a holding furnace or a tilting furnace used for treatment, processing, or casting of molten metals.

FIG. 2 illustrates an example of a submergence impeller 200, according to the instant disclosure. The submergence impeller 200 includes a drive shaft 202, helical fins 204A-204D (collectively helical fins 204), plate 206, and flare 208. The drive shaft 202 may have a length from a first end to a second end from twenty to one hundred and twenty centimeters, or more in some examples. The drive shaft 202 may have a diameter from one centimeter to five centimeters, or more in some examples.

The drive shaft 202 may be formed of an abrasion resistant material to reduce oxide-related erosion that may shorten the lifespan of the drive shaft 202. In some examples, the material forming the drive shaft 202 may be coated in an abrasion resistant material. For example, a steel shaft may be coated in a fiber castable refractory, such as SIFCA® refractory slurry with stainless steel fiber offered by Wahl Refractory Solutions of Fremont, OH. Multiple layers of refractory materials may be coated around the steel drive shaft to provide protection against erosion.

The helical fins 204 are shown with four helical fins 204A, 204B, 204C, and 204D though less than four or more than four may be used in some examples. The helical fins 204 may have a pitch angle from twenty degrees to eighty degrees with respect to the plate 206. In an embodiment as shown, the helical fins 204 have a constant pitch angle, though in some examples the helical fins may have variable pitch angles, such as a first pitch angle and a vertical flat portion adjacent the plate 206 and a second pitch angle away from the plate 206. The helical fins 204 may have a thickness of less than one centimeter to over three centimeters in some examples. The helical fins 204 abut and couple to the plate 206 shown as a circular plate, though other shapes of plate 206 may be used. The plate 206 may have a thickness of less than one centimeter to over three centimeters in some examples. The impeller includes a flare 208 adjacent the location where the drive shaft 202 meets the plate 206. The flare 208 may be a gradual taper of the diameter of the drive shaft 202 out to meet the plate 206 and increase the strength of the joint between the plate 206 and drive shaft 202 as well as provide for additional outward direction of molten metal while the impeller 200 is spinning. In some examples, the taper of the flare 208 may be linear, parabolic, exponential, or follow some other profile.

In some examples, the plate 206 may be positioned at or within a threshold distance of the floor or bottom portion of a furnace. For example, the plate 206 may be positioned, in some examples within two centimeters or less of the floor of the furnace. In some examples the plate 206 may be positioned less than five centimeters from the floor of the furnace. In operation, the plate 206 being at or as close as possible to the floor of the furnace may improve performance of the submergence impeller. Reducing the distance from the plate 206 to the floor may also prevent formation of a stagnant zone underneath the impeller.

In some examples, the impeller 200 may have a hub or interface on an underside of the plate 206 for engaging with a feature within the floor of the furnace. As the impeller 200 operates in close proximity with the floor of the furnace, any wobble or imbalance in the impeller may cause the impeller to run against the floor. The hub is aligned with the center axis of the drive shaft 202 such that the hub can be used to support the end of the impeller 200 under the plate 206 and prevent wobbling, rubbing, or unintended torque on the impeller 200 and/or drive shaft 202 that may damage the drive shaft 202. The hub may include a protrusion such as a point that extends from the surface of the plate 206 and provides a contact point, e.g., similar to a spinning top, that may provide additional stability to the impeller 200 during operation. In some examples, the hub may include a recessed portion within the plate 206 that may mate with a protrusion at the floor of the furnace, with the protrusion resting within the recessed portion of the hub.

FIG. 3 illustrates an example of a submergence impeller 304, according to the instant disclosure. The submergence impeller 304 is shown submerged in a cut away of a furnace chamber 300. The furnace chamber may include block 306 which may be the same as or similar to shaped block 108 of FIG. 1. A surface 302 of the molten metal shows an example of surface displacement as a result of submergence caused by spinning the impeller 304. The impeller includes a drive shaft 308, helical fins 310, flare 312, and plate 314 similar to the drive shaft 202, helical fins 204, plate 206, and flare 208 of FIG. 2. The impeller 304 also includes vertical segments 316 that extend perpendicular to the plate 314 and couple the plate 314 and the helical fins 310. The vertical segment 316 may have a height from one centimeter to five centimeters or more in some examples. The vertical segment 316 may improve a pumping ability of the impeller 304 in addition to submergence and provide for pumping of molten metal radially away from the drive shaft 308.

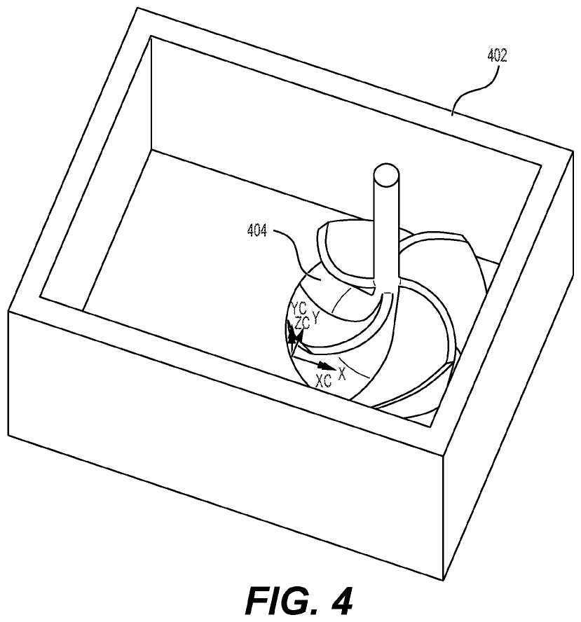

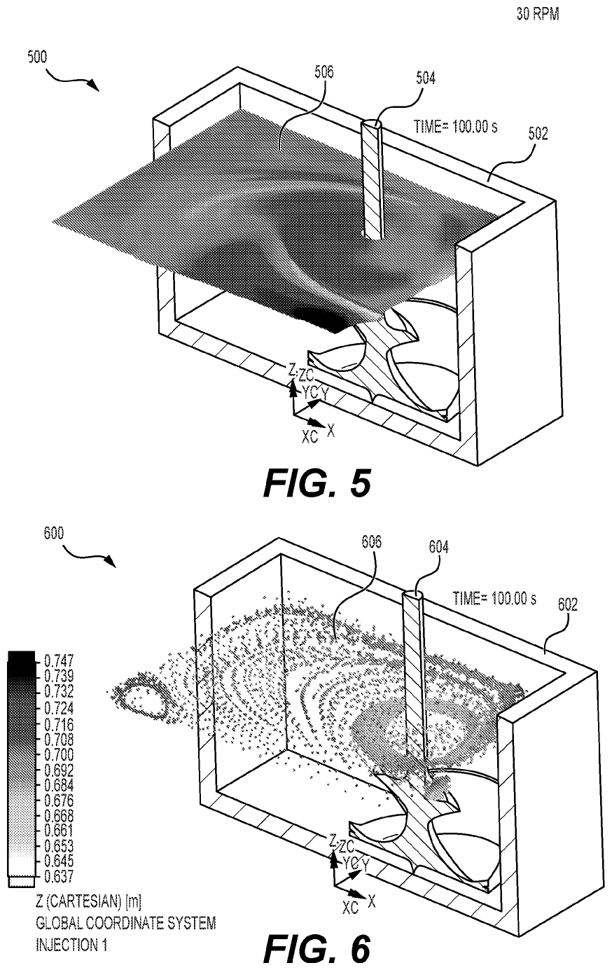

FIG. 4 illustrates an example set a submergence impeller 404 in a mixing chamber 402, according to the instant disclosure. The mixing chamber 402 may be a furnace, a side well of a furnace, or other container for holding molten metal for processing, melting, alloying, or otherwise handling. FIGS. 5-14 show section views of the mixing chamber 402 with the impeller 404 showing submergence action as a result of impeller rotation at varying rotation speeds. The impeller 404 may be the impeller 200 or 304 of FIG. 2 or 3 or other impeller described herein in some examples.

FIGS. 5-6 illustrate fluid dynamics models 500 and 600 of the submergence impellers 504 and 604 rotating at a first speed within a chamber 502 and 602, according to the instant disclosure. The chamber 502 and 602 is filled with molten metal and has an upper surface 506 where particles 606 are introduced in the model. The first speed may be from twenty-five to thirty rpm. FIG. 6 illustrates submergence of the particles originally introduced at the surface, with the color bar indicating a submergence depth of the particles.

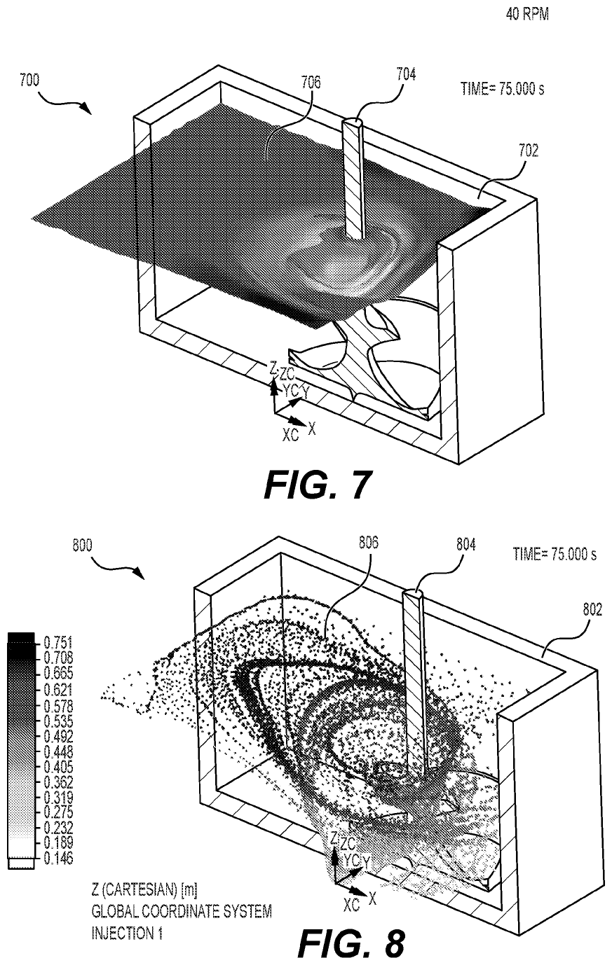

FIGS. 7-8 illustrate fluid dynamics models 700 and 800 of the submergence impellers 704 and 804 rotating at a second speed within a chamber 702 and 802, according to the instant disclosure. The chamber 702 and 802 is filled with molten metal and has an upper surface 706 where particles 806 are introduced in the model. The second speed may be from thirty-five to forty-five rpm. FIG. 8 illustrates submergence of the particles originally introduced at the surface, with the color bar indicating a submergence depth of the particles.

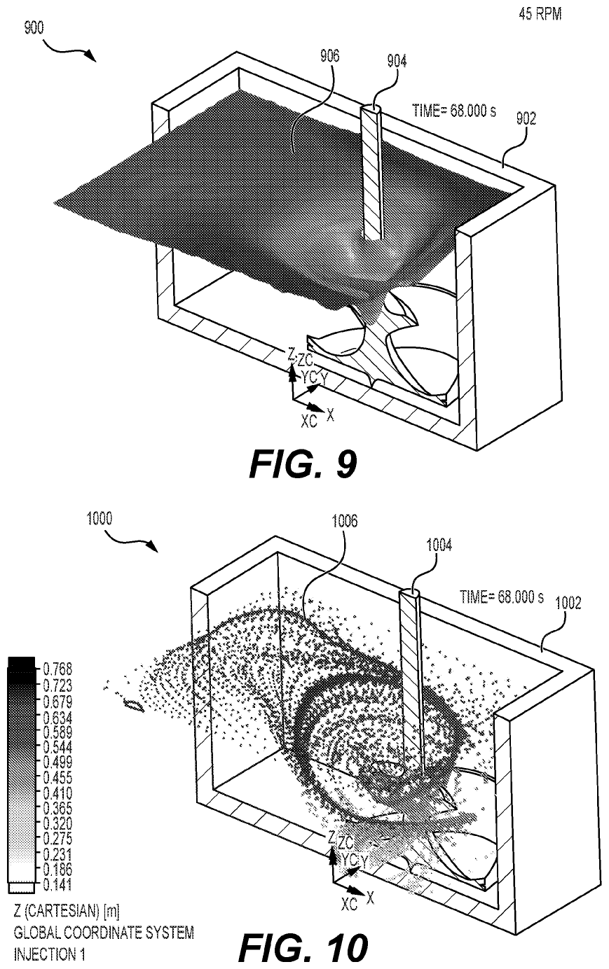

FIGS. 9-10 illustrate fluid dynamics models 900 and 1000 of the submergence impellers 904 and 1004 rotating at a third speed within a chamber 902 and 1002, according to the instant disclosure. The chamber 902 and 1002 is filled with molten metal and has an upper surface 906 where particles 1006 are introduced in the model. The third speed may be from forty to forty-five rpm. FIG. 10 illustrates submergence of the particles originally introduced at the surface, with the color bar indicating a submergence depth of the particles.

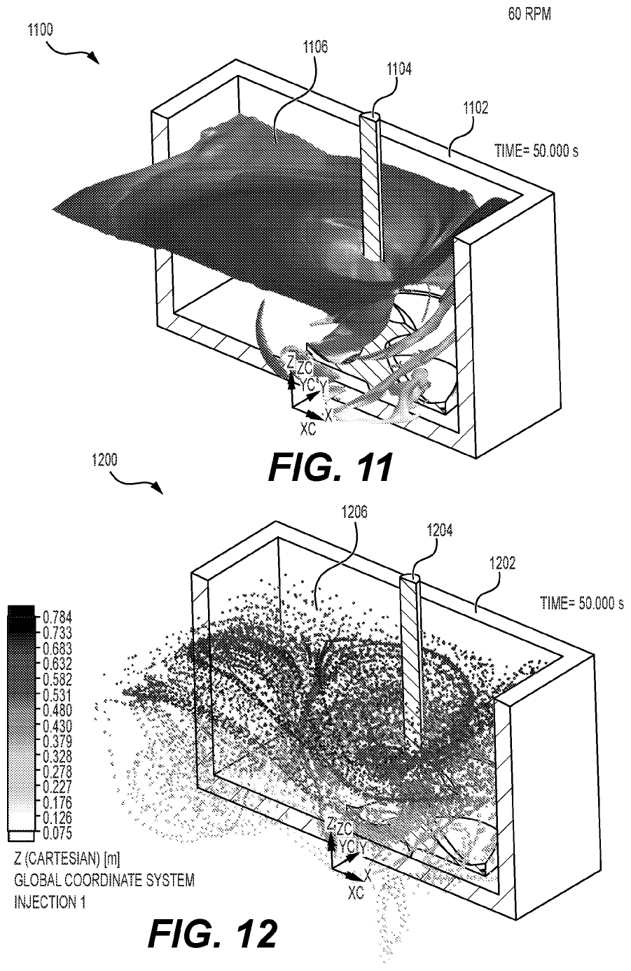

FIGS. 11-12 illustrate fluid dynamics models 1100 and 1200 of the submergence impellers 1104 and 1204 rotating at a fourth speed within a chamber 1102 and 1202, according to the instant disclosure. The chamber 1102 and 1202 is filled with molten metal and has an upper surface 1106 where particles 1206 are introduced in the model. The fourth speed may be from fifty to sixty-five rpm. FIG. 12 illustrates submergence of the particles originally introduced at the surface, with the color bar indicating a submergence depth of the particles.

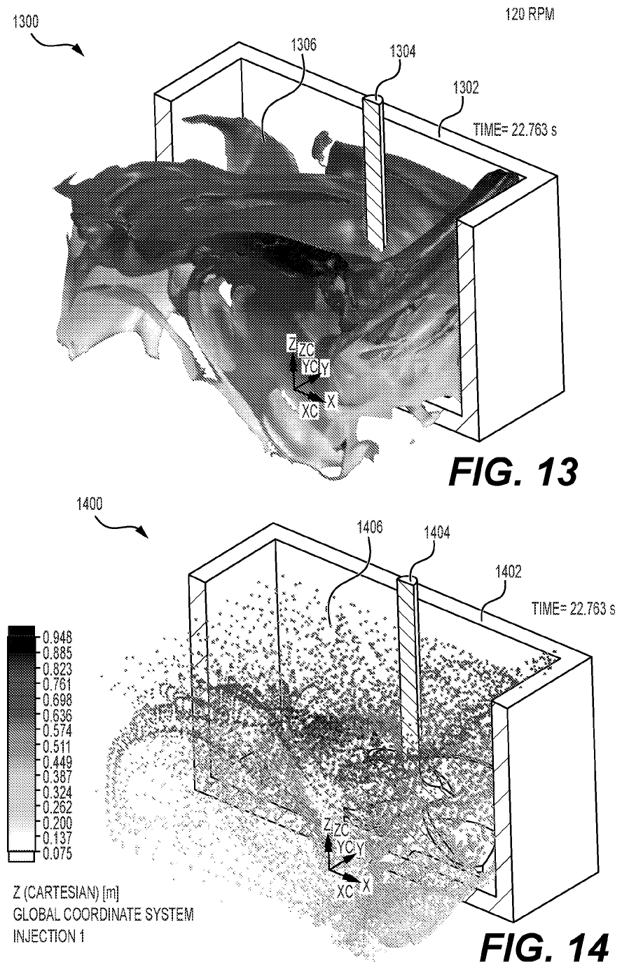

FIGS. 13-14 illustrate fluid dynamics models 1300 and 1400 of the submergence impellers 1304 and 1404 rotating at a fifth speed within a chamber 1302 and 1402, according to the instant disclosure. The chamber 1302 and 1402 is filled with molten metal and has an upper surface 1306 where particles 1406 are introduced in the model. The fifth speed may be from one hundred to one hundred and twenty rpm. FIG. 14 illustrates submergence of the particles originally introduced at the surface, with the color bar indicating a submergence depth of the particles.

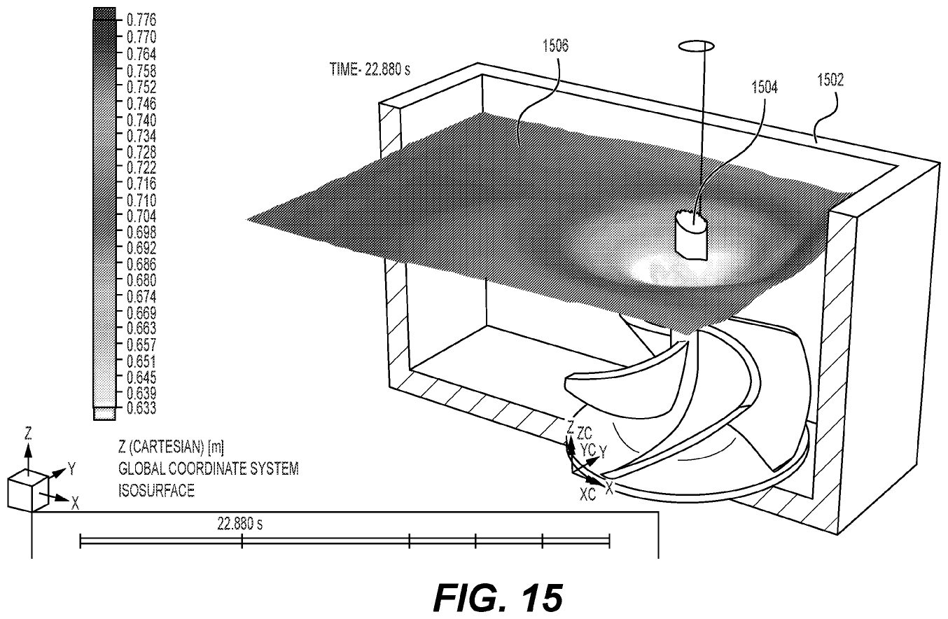

FIG. 15 illustrates submergence and surface subduction of a molten metal using a submergence impeller 1504, according to the instant disclosure. The submergence impeller 1504 is included in a chamber 1502 which may be the same as the chambers of FIGS. 5-14. The surface 1506 shows surface deflection and subduction as a result of the spinning impeller 1504. The color bar indicates surface subduction in meters and shows a surface distortion of up to ten centimeters from the edge of the chamber to the center of the vortex around the impeller 1504.

The following paragraphs provide examples as described herein, in some examples, the paragraphs and features described therein may be combined with other examples and paragraphs.

A. An impeller, comprising: a drive shaft having a first end and a second end, the drive shaft rotated at the first end by a rotation device; a plate coupled to the second end of the drive shaft, the drive shaft extending perpendicularly from the plate; and a helical impeller adjacent the second end of the drive shaft and coupled to a first surface of the plate.

B. The impeller of paragraph A, wherein the helical impeller comprises a ceramic or refractory material.

C. The impeller of paragraph A, further comprising a pivot protruding from a second surface of the plate, the second surface opposite the first surface, the pivot configured to interface with a bottom of a furnace to support the impeller during operation.

D. The impeller of paragraph A, wherein the helical impeller comprises three helical fins that extend radially from the drive shaft to a perimeter of the plate, the three helical fins having a first height adjacent the drive shaft and a second height adjacent the perimeter of the plate, the first height greater than the second height.

E. The impeller of paragraph D, wherein the three helical fins form a pitch angle with respect to the plate of between twenty degrees and eighty degrees.

F. The impeller of paragraph A, wherein the helical impeller comprises: a first portion adjacent the plate, the first portion perpendicular to the plate; and a second portion extending from the first portion in and having a pitch angle with respect to the plate of between twenty degrees and eighty degrees.

G. The impeller of paragraph A, wherein the drive shaft, the plate, and the helical impeller are coated with an abrasion resistant coating.

H. The impeller of paragraph A, wherein a perimeter of the plate is circular.

I. The impeller of paragraph A, further comprising a receiving hub formed in the plate on a second surface of the plate opposite the first surface, the receiving hub configured to receive a protrusion from a floor of a furnace chamber to support the impeller during rotation.

J. A system, comprising, a chamber for containing molten metal; and a mixing impeller comprising: a drive shaft having a first end and a second end, the drive shaft configured to be driven at the first end by a rotation device; a plate coupled to the second end of the drive shaft, the drive shaft extending perpendicularly from the plate; and a helical impeller adjacent the second end of the drive shaft and coupled to a first surface of the plate.

K. The system of paragraph J, wherein the chamber comprises a primary chamber and a secondary chamber, the secondary chamber in fluid communication with the primary chamber, and wherein the mixing impeller is positioned within the secondary chamber configured to agitate molten metal within the secondary chamber.

L. The system of paragraph K, further comprising a block positioned adjacent the mixing impeller between the secondary chamber and the primary chamber, the block configured to produce a first conduit and a second conduit for conveying molten metal between the primary chamber and the secondary chamber. T

M. he system of paragraph J, wherein the mixing impeller comprises a pivot protruding from a second surface of the plate, the second surface opposite the first surface, the pivot configured to interface with a bottom of a furnace to support the mixing impeller during operation.

N. The system of paragraph M, wherein the chamber comprises a recess positioned on a floor and aligned with an axis of the drive shaft, the recess configured to interface with the pivot of the mixing impeller.

O. The system of paragraph J, wherein the helical impeller comprises: a first portion adjacent the plate, the first portion perpendicular to the plate; and a second portion extending from the first portion and having a pitch angle with respect to the plate of between twenty degrees and eighty degrees.

P. The system of paragraph J, wherein the drive shaft comprises a steel drive shaft coated with an abrasion resistant refractory coating.

Q. The system of paragraph J, wherein the helical impeller comprises three helical fins that extend radially from the drive shaft to a perimeter of the plate, the three helical fins having a first height adjacent the drive shaft and a second height adjacent the perimeter of the plate, the first height greater than the second height.

R. The system of paragraph Q, wherein the three helical fins form a pitch angle with respect to the plate of between twenty degrees and eighty degrees.

S. The system of paragraph J, wherein the mixing impeller comprises at least one of ceramic, graphite, or refractory.

T. A submergence-mixing impeller, comprising: a drive shaft having a first end, a second end, and an axis, the drive shaft rotated about the axis by a rotation device coupleable to the first end; a circular plate coupled to the second end of the drive shaft, the drive shaft extending perpendicularly from the circular plate, the circular plate comprising a tapered flare from a first height adjacent the drive shaft to a second height along a surface of the circular plate; and a helical impeller adjacent the second end of the drive shaft and coupled to a first surface of the circular plate, the helical impeller comprising: a first portion adjacent the first surface of the circular plate, the first portion perpendicular to the circular plate; and a second portion extending from the first portion and having a pitch angle with respect to the circular plate of between twenty degrees and eighty degrees.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. An impeller, comprising:
a drive shaft having a first end and a second end, the drive shaft rotated at the first end by a rotation device;
a plate coupled to the second end of the drive shaft, the drive shaft extending perpendicularly from the plate; and
a helical impeller adjacent the second end of the drive shaft and coupled to a first surface of the plate.

2. The impeller of claim 1, wherein the helical impeller comprises a ceramic or refractory material.

3. The impeller of claim 1, further comprising a pivot protruding from a second surface of the plate, the second surface opposite the first surface, the pivot configured to interface with a bottom of a furnace to support the impeller during operation.

4. The impeller of claim 1, wherein the helical impeller comprises three helical fins that extend radially from the drive shaft to a perimeter of the plate, the three helical fins having a first height adjacent the drive shaft and a second height adjacent the perimeter of the plate, the first height greater than the second height.

5. The impeller of claim 4, wherein the three helical fins form a pitch angle with respect to the plate of between twenty degrees and eighty degrees.

6. The impeller of claim 1, wherein the helical impeller comprises:
a first portion adjacent the plate, the first portion perpendicular to the plate; and
a second portion extending from the first portion in and having a pitch angle with respect to the plate of between twenty degrees and eighty degrees.

7. The impeller of claim 1, wherein the drive shaft, the plate, and the helical impeller are coated with an abrasion resistant coating.

8. The impeller of claim 1, wherein a perimeter of the plate is circular.

9. The impeller of claim 1, further comprising a receiving hub formed in the plate on a second surface of the plate opposite the first surface, the receiving hub configured to receive a protrusion from a floor of a furnace chamber to support the impeller during rotation.

10. A system, comprising,
a chamber for containing molten metal; and
a mixing impeller comprising:
a drive shaft having a first end and a second end, the drive shaft configured to be driven at the first end by a rotation device;
a plate coupled to the second end of the drive shaft, the drive shaft extending perpendicularly from the plate; and
a helical impeller adjacent the second end of the drive shaft and coupled to a first surface of the plate.

11. The system of claim 10, wherein the chamber comprises a primary chamber and a secondary chamber, the secondary chamber in fluid communication with the primary chamber, and wherein the mixing impeller is positioned within the secondary chamber configured to agitate molten metal within the secondary chamber.

12. The system of claim 11, further comprising a block positioned adjacent the mixing impeller between the secondary chamber and the primary chamber, the block configured to produce a first conduit and a second conduit for conveying molten metal between the primary chamber and the secondary chamber.

13. The system of claim 10, wherein the mixing impeller comprises a pivot protruding from a second surface of the plate, the second surface opposite the first surface, the pivot configured to interface with a bottom of a furnace to support the mixing impeller during operation.

14. The system of claim 13, wherein the chamber comprises a recess positioned on a floor and aligned with an axis of the drive shaft, the recess configured to interface with the pivot of the mixing impeller.

15. The system of claim 10, wherein the helical impeller comprises:
a first portion adjacent the plate, the first portion perpendicular to the plate; and
a second portion extending from the first portion and having a pitch angle with respect to the plate of between twenty degrees and eighty degrees.

16. The system of claim 10, wherein the drive shaft comprises a steel drive shaft coated with an abrasion resistant refractory coating.

17. The system of claim 10, wherein the helical impeller comprises three helical fins that extend radially from the drive shaft to a perimeter of the plate, the three helical fins having a first height adjacent the drive shaft and a second height adjacent the perimeter of the plate, the first height greater than the second height.

18. The system of claim 17, wherein the three helical fins form a pitch angle with respect to the plate of between twenty degrees and eighty degrees.

19. The system of claim 10, wherein the mixing impeller comprises at least one of ceramic, graphite, or refractory.

20. A submergence-mixing impeller, comprising:
a drive shaft having a first end, a second end, and an axis, the drive shaft rotated about the axis by a rotation device coupleable to the first end;
a circular plate coupled to the second end of the drive shaft, the drive shaft extending perpendicularly from the circular plate, the circular plate comprising a tapered flare from a first height adjacent the drive shaft to a second height along a surface of the circular plate; and
a helical impeller adjacent the second end of the drive shaft and coupled to a first surface of the circular plate, the helical impeller comprising:
a first portion adjacent the first surface of the circular plate, the first portion perpendicular to the circular plate; and
a second portion extending from the first portion and having a pitch angle with respect to the circular plate of between twenty degrees and eighty degrees.
